(19) United States
(12) Patent Application Publication
(10) Pub. No.: US 2015/0291447 A1
(43) Pub. Date: Oct. 15, 2015

(54) Application of Dealumination Y Type Zeolite in Degrading Organic Pollutants in Water Under Microwave Induction

(71) Applicant: Guangzhou Institute of Geochemistry, Chinese Academy of Sciences, Guangzhou City, Guangdong Prov. (CN)

(72) Inventors: Erdan Hu, Guangzhou City (CN); Hefa Cheng, Guangzhou City (CN); Yuanan Hu, Guangzhou City (CN)

(21) Appl. No.: 14/375,227

(22) PCT Filed: Oct. 9, 2012
(86) PCT No.: PCT/CN2012/082639

§ 371 Date: Jul. 29, 2014

(30) Foreign Application Priority Data
Sep. 26, 2012 (CN) 201210363143.X

(51) Int. Cl. C02F 1/28; B01J 20/18; C02F 1/30

(52) U.S. Cl. CPC C02F 1/281; C02F 1/302; B01J 20/186; C02F 2101/30

(57) ABSTRACT

Disclosed is an application of dealuminated Y type zeolite in degrading organic pollutants in water under microwave induction. The dealuminated Y type zeolite, with the cation being H+ and a mol ratio of SiO2 to Al2O3 being 60, is applied to degrading the organic pollutants in the water under microwave induction. The degrading rate of atrazine is up to 67.40 nmol/min under the radiation of 700 W microwave (2.450 GHz) at the laboratory simulation condition.

### TECHNICAL FIELD

The present invention relates to an application of a dealuminated Y zeolite, particularly relates to the application of a dealuminated Y zeolite in sorptive removal of organic contaminants from water followed by destruction with microwave-induced degradation.

### BACKGROUND OF THE INVENTION

With the rapid development of industries and increasing improvement of the living standard of people, serious pollution of aquatic environment by organic pollutants has become a common problem. Some of the organic pollutants can be enriched through food chains, and pose serious risk to human health.

Various treatment technologies, such as activated carbon adsorption, advanced oxidation processes (AOPs), biodegradation, and zero-valent metal reduction, have been developed to remove organic contaminants from water. However, most of the traditional treatment processes are limited by problems such as low treatment efficiency, high cost, generation of secondary pollution and incomplete degradation of pollutants. Therefore, they cannot meet the need of pollution control, particularly the treatment of wastewater containing organic pollutants at high concentrations.

Microwaves refer to electromagnetic waves with frequencies between 0.3 and 300 GHz. The enhancement of reaction rates by microwave irradaition has been attributed to the heating effect and the lowering of the overall activation energy for a kinetic process. Recently, microwave technology has been used to eliminate environmental pollutants and has achieved some promising results. Microwave irradiation can be effective at decomposing organic substances sorbed on granular activated carbon, which is an excellent dielectric material to absorb and convert microwave energy into thermal energy. However, microwave irradiation also results in great damages to the structure of the activated carbon, thus it is only applicable for short-time treatment. Microwave irradiation for a long time can even cause fire on the activated carbon surface. Serious damage of the pore structure, and significant reduction in the specific surface area often occur on the activated carbon after microwave regeneration. In addition, due to strong microwave absorption of activated carbon itself, the microwave energy can't penetrate very deep through the sorption bed, significantly limiting the size of sorption column.

Zeolite is a group of natural or synthetic microporous aluminosilicate minerals with important technological applications in separation, sorption, and catalysis. They are composed of [SiO₄]⁴⁻and [AlO₄]⁵⁻tetrahedra arranged in three dimensional frameworks by sharing oxygen atoms, which creates interconnecting cages and channels and results in structures with high volumes of micropores (<2 nm)and mesopores (2-50 nm) and large surface areas. The negative charge of the aluminosilicate framework is balanced by exchangeable cations within the cages and channels. Y zeolite has a faujasite framework structure with SiO₂/Al₂O₃ molar ratio of about 3.0. The structural unit of Y zeolite is the β cage, and the β cages are connected with each other by the hexagonal column cages, which are formed by the six-membered rings, and surround as a supercage, which is called as faujasite cage (with a diameter of 12 A). The faujasite cages are connected with each other through twelve-membered ring window, and form the primary pore channel, with a diameter of 7.4 A. Dealuminated zeolites (high-silicon zeolites) are prepared by introducing organic amine as structure-directing agent or template during the synthesis process, then stabilization with steam, dealumination and silicon addition. They have high thermal stability, good acid resistance and hydrothermal stability, and can be easily regenerated. In addition, dealuminated zeolites have good sorption capacity for organics due to their high hydrophobicity. With low surface cation density, dealuminated zeolites have low dielectric constants amd are essentially microwave transparent, which allow microwave energy to penetrate through easily.

Sorption by dealuminated Y zeolites coupled with microwave-induced degradation could be used for treatment of organic contaminants from water. With hydrophobic pore wall surfaces, the dealuminated Y zeolite can selectively uptake organic contaminants from aqueous streams. The framework of the dealuminated Y zeolite is essentially transparent to microwave, while organic molecules sorbed in the hydrophobic spaces of zeolite micropores are subjected to interfacial selective heating under microwave irradiation, leading to rapid decomposition via pyrolysis. Therefore, design and selection of a dealuminated Y zeolite that can effectively uptake organic contaminants from water and perform well in the microwave-induced degradation process will greatly improve the treatment efficiency and save energy.

### SUMMARY OF THE INVENTION

The objective of the invention is to provide the application of a dealuminated Y zeolite in sorptive removal of organic contaminants from water followed by destruction with microwave-induced degradation.

In order to achieve the above goal, the invention adopts the following technical solution: the application of a dealuminated Y zeolite in sorptive removal of organic contaminants from water, followed by destruction of the sorbed contaminants by microwave-induced degradation.

Preferably, the SiO₂/Al₂O₃ molar ratio of the dealuminated Y zeolite is 60.

Preferably, the surface cations of the dealuminated Y zeolite are H⁺.

Preferably, the application of the dealuminated Y zeolite with SiO₂/Al₂O₃ molar ratio of 60, surface cations of H⁺to remove organic contaminants from water, followed by destruction of the sorbed contaminants with microwave-induced degradation. The dealuminated Y zeolite according to the invention, with SiO₂/Al₂O₃ molar ratio of 60, surface cations of H⁺, has strong sorption capacity and selectivity for the organic contaminants from water, the surface cations of the zeolites have weak hydration capacity, and the zeolte framework is transparent to microwave irradiation, which make it favorable for adsorbing organic contaminants from water and the sorbed organic contaminants can be degraded effectively under microwave irradiation.

### Beneficial Effects of the Invention

The dealuminated Y zeolite according to the invention has strong sorption capacity of organic contaminants from water, very weak microwave absorption itself, so the organic contaminants sorbed in the micropores of the zeolite can be degraded rapidly under microwave irradiation. The disclosed dealumination Y zeolite with SiO₂/Al₂O₃ molar ratio of 60, surface cations of H⁺ is used to remove organic contaminants from water, followed by complete destruction of the sorbed contaminants under microwave irradiation. In laboratory simulation experiments, its sorption efficiency of the endocrine disruptor, atrazine, from water is up to 91.3% and the degradation rate is up to 67.40 nmol/min when the initial content of atrazine in the zeolite is 1224.1 nmol/g.

### DETAILED DESCRIPTION OF THE INVENTION

The present invention will now be further illustrated by referring to the specific embodiments of the invention, but the invention is not limited by the embodiments.

### Embodiments

2.5 g of the dealuminated Y zeolite with SiO₂/Al₂O₃ molar ratio of 60, surface cations of H⁺was added into 200 mL 40.70 nmol/L atrazine solution. After equilibration for 24 h, the concentration of atrazine in the solution was 3.56 nmol/L. The solution phase was removed by filtration, followed by freeze-drying of the sorbent at −50 ° C. for 12 h, then 0.3 g of the sorbent was treated under 700 W microwave (2.450 GHz) irradiation for 4 min. Extraction of the zeolite after microwave irradiation showed that the atrazine sorbed on the zeolite was completely degraded.

### Effect of Different Surface Cations on the Treatment Process

Sorptive removal and microwave-induced degradation of a endocrine disruptor, atrazine, were conducted on a series of Y zeolites with the same SiO₂/Al₂O₃ molar ratio of 5.1 but different surface cations of Na+, NH₄⁺, H⁺, Ca²⁺, and Mg²⁺, respectively. The experiment was conducted as follows: equilibration of 2.5 g zeolites in 200 mL of 40.7 μmol/L atrazine solution for 24 h, followed by separation of the sorbents by vacuum filtration and water removal by freeze-drying at −50 ° C. for 12 h. Then 0.3 g of the sorbents were treated under 700 W microwave (2.450 GHz) irradiation. The contents of atrazine remained in the zeolites with different microwave irradiation time were measured after recovery by solvent extraction. The degradation rates of atrazine sorbed in the zeolites with different surface cations are shown in Table 1.

TABLE 1
Effect of Surface Cations on Microwave-induced Degradation
Rate of Atrazine Sorbed in the Zeolite Micropores

| SiO₂/Al₂O₃ Molar Ratio | 5.1 | | | | |
|---|---|---|---|---|---|
| Surface cations | Na⁺ | Ca²⁺ | Mg²⁺ | NH₄⁺ | H⁺ |
| Degradation Rate (nmol/min) | 4.35 | 0.49 | 1.34 | 6.84 | 3.23 |

As can be seen in Table 1, at SiO₂/Al₂O₃ molar ratio of 5.1, the degradation rates of atrazine sorbed on zeolites with surface cations of Ca²⁺ and Mg²⁺, which have higher hydration free energies, are lower. In contrast, the degradation rates on the zeolites with surface cations of lower hydration free energies, such as Na⁺, NH₄⁺, and H⁺, are much faster. As NH₄⁺ is unstable and may be decomposed at high temperature, and the microwave absorption of NaY zeolite is much stronger than HY zeolite, H⁺ is selected as the most suitable type of cation for the zeolites, which are expected to have lower energy consumption and allow greater penetration depth of microwave in application compared to the zeolites with other types of cations.

### Effect of Different SiO₂/Al₂O₃ Ratio on the Treatment Process

A series of HY zeolites with SiO₂/Al₂O₃ ratios of 5.1, 30, 60, and 80 respectively, were used in the sorptive removal of atrazine, followed by destruction of the sorbed atrazine by microwave-induced degradation, following procedures described above. The degradation rates of atrazine sorbed on the zeolites with different SiO₂/Al₂O₃ ratios are shown in Table 2.

TABLE 2
Effect of SiO₂/Al₂O₃ Ratio on the Microwave-induced Degradation
Rate of Atrazine Sorbed in the Zeolite Micropores

| | |
|---|---|
| Surface cations | H⁺ |

| SiO₂/Al₂O₃ Molar Ratio | 5.1 | 30 | 60 | 80 |
|---|---|---|---|---|
| Degradation Rate (nmol/min) | 3.23 | 51.96 | 67.40 | 22.29 |

As Table 2 shows, the microwave-induced degradation rate of atrazine sorbed on the HY zeolite with SiO₂/Al₂O₃ molar ratio of 60 is the highest.

1. A method for sportive removal of organic contaminants from water, comprising applying a dealuminated Y zeolite to water containing the organic contaminants, allowing sorption of the contaminants onto the zeolite, and destroying the contaminants sorbed onto the zeolite with microwave-induced degradation.

2. The method of claim 1, wherein a SiO₂/Al₂O₃ molar ratio of the dealuminated Y zeolite is 60.

3. The method of claim 1, wherein surface cations of the dealuminated Y zeolite are H⁺.

4. The method of claim 1, comprising applying a dealuminated Y zeolite with a SiO₂/Al₂O₃ molar ratio of 60 and surface cations of H⁺ to water containing organic contaminants, allowing sorption of the contaminants onto the zeolite, and destroying the contaminants sorbed onto the zeolite with microwave-induced degradation.
